(19) United States
(12) Patent Application Publication
(10) Pub. No.: US 2022/0144020 A1
(43) Pub. Date: May 12, 2022

(54) IMPROVED ADAPTER AND ROLLING ASSEMBLY COMPRISING SUCH AN ADAPTER

(71) Applicant: COMPAGNIE GENERALE DES ETABLISSEMENTS MICHELIN, Clermont-Ferrand (FR)

(72) Inventors: DANIEL WALSER, Clermont-Ferrand (FR); BERTRAND VEDY, Clermont-Ferrand (FR)

(21) Appl. No.: 17/415,805

(22) PCT Filed: Dec. 19, 2019
(86) PCT No.: PCT/FR2019/053200

§ 371 Date: Jun. 18, 2021

(30) Foreign Application Priority Data
Dec. 20, 2018 (FR) FR1873494
Feb. 1, 2019 (FR) FR1900984

(51) Int. Cl. B60C 15/02; B60B 21/10; B60B 25/12

(52) U.S. Cl. CPC B60C 15/0209; B60B 21/10; B60B 2900/3312; B60B 2900/351; B60B 2360/36; B60B 25/12

(57) ABSTRACT

Adapter for a rolling assembly, of axis of rotation X-X′, comprising a tire (2), a rim (3), and an adapter (100), said adapter comprising an axially inner end (10), an axially outer end (11) and a body (12), wherein said axially outer end comprises an outer reinforcing element (15) which is a structure substantially of revolution about the axis X-X′ comprising a plurality of windings of at least one wire that are arranged axially beside one another over several layers radially superposed on one another. The section of the outer reinforcement (15) has a ratio of moments of inertia Ix/Iy of greater than 1.3 for an axial width of between 6 and 9 mm, where Ix is the moment of inertia around a first axis passing through its centre of gravity and parallel to the axis of rotation X-X′, and Iy is the moment of inertia around a second axis passing through its centre of gravity and perpendicular to the first axis.

The subject of the invention is an adapter for a rolling assembly consisting of a tyre and a rigid rim connected together by an adapter capable of offering a certain elastic flexibility during an impact undergone during rolling, as well as a rolling assembly comprising it. A tyre comprises, as is known, two beads intended to be mounted on the seats of a rim. The present invention relates to rolling assemblies in which a tyre bead is not mounted directly on a rigid rim, but is mounted on a flexible adapter, which adapter is, for its part, mounted on a rigid rim.

A tyre, a rim, and an adapter, as discussed in the present invention, are usually described by a representation in a meridian plane, that is to say a plane containing the axis of rotation of the tyre. All these products (the tyre, the rim, the adapter) are objects having a geometry of revolution with respect to the axis of rotation of the tyre. The radial and axial directions respectively denote the first direction, a direction perpendicular to the axis of rotation of the tyre, and the second direction, a direction parallel to the axis of rotation of the tyre. In the following text, the expressions “radially” and “axially” mean “in a radial direction” and “in the axial direction”, respectively. The expressions “radially inner and radially outer” respectively mean “closer to and further away from the axis of rotation of the tyre, in a radial direction”. A median plane is a plane perpendicular to the axis of rotation of the tyre, positioned axially so as to intersect the surface of the tread substantially midway between the beads of a tyre. The expressions “axially inner and axially outer” respectively mean “closer to and further away from the median plane of the tyre, in the axial direction”. Moreover, by “radial cross section” or “radial section” is to be understood a cross section or a section along a plane which contains the axis of rotation of the tyre.

Document WO2016/046197 proposes arranging a flexible adapter between a tyre bead and a rim. The rolling assembly according to that document comprises a tyre, a rim and two identical adapters. Considering the language conventions recalled above, and referring to the way in which an adapter is mounted on a rim, such an adapter comprises, axially from the inside to the outside, an axially inner end called the adapter bead and intended to ensure the attachment of the adapter to the rim. Such an adapter also comprises an axially outer end intended to receive and axially immobilize a tyre bead. A body connects the two, respectively axially inner and axially outer, ends. The adapters are mounted on a rim, which is an aluminium part most of the time. The rim has, on each side, a rim hook intended in particular to ensure immobilization in the axial direction of the adapter.

A flexible adapter must, on the one hand, have a certain elastic flexibility, for example during an impact against a curb or when passing into a “pothole” and, on the other hand, it must have sufficient rolling rigidity in order to give the vehicle correct behaviour and to allow, beforehand, for a wheel comprising it to pass the various validation tests, such as the high-pressure inflation test or the biaxial endurance test (generally known under the name ZWARP test). In order to satisfy all these conditions, the ends of the adapter are provided with reinforcing elements connected by at least one reinforcing ply, and more particularly the axially outer end of the adapter is provided with an annular bead wire with a section of generally circular shape made generally of a plurality of steel wire strands.

In document WO2017/191389, there is proposed such a flexible adapter comprising an annular bead wire of generally polygonal section produced on the basis of a unitary metal wire wound contiguously around a support at least three times in an axial direction and at least two times in a radial direction. The bead wire is surrounded by rubber plies and forms with the latter the axially outer end of the adapter which supports the bead of the tyre and is situated axially on the outside thereof.

The adapters are mounted on a metal rim which is mostly an aluminium part. The rim has, on each side, a rim hook intended in particular to ensure immobilization in the axial direction of the adapter. On a metal rim without an adapter for passenger vehicle wheels, one most frequently encounters “J”-type hooks with a width of between 11 and 15 mm. However, the ETRTO (for European Tyre and Rim Technical Organization) standard also defines “J-N”-type hooks for an aluminium rim whose width is between 8 and 15 mm. Such a hook is narrower than a “J”-type hook, which makes it possible to save weight but also to better protect the central part of the rim against curb scrapings.

However, in the case of a rolling assembly comprising a rim and a tyre connected by a flexible adapter, it has been observed that the axially outer end of the adapter projects relative to the rim hook by an axial width which is quite significant, with the consequence that it is more exposed to curb scrapings. It is therefore necessary to reduce the axial width of the axially outer end of the adapter.

Thus, to solve this problem, starting from the solution described in document WO2017/191389, we would certainly have tried to increase the section of the unitary wire of the winding constituting the outer reinforcement, while reducing the number of windings for a section of given shape, as described in that document. As the moment of inertia in bending of a circular section varies with the power of four of the diameter of the wire while its section varies only with the square of the latter, we could reduce the overall section of the reinforcement while maintaining its moment of inertia in bending. In such a configuration, each wire would therefore be larger and would have a greater moment of inertia in bending. This would nevertheless have the drawback of making the wire less suitable for regaining its original shape after an imposed deformation. In other words, such a reinforcement would plasticize more easily upon impact against a curb, which would result in deforming and therefore no longer being able to provide the elastic flexibility required during such an impact.

The object of the invention is to remedy the aforementioned drawbacks and to provide an adapter for a rolling assembly produced in such a way as to guarantee sufficient mechanical stability in rolling motion and to withstand impacts without permanently deforming, while making it possible to protect its axially outer end during curb scrapings.

The subject of the invention is therefore an adapter for a rolling assembly, of axis of rotation X-X′, comprising a tyre, having two beads and a rim, the adapter being intended to provide the junction between one of the beads and the rim, said adapter comprising an axially inner end, an axially outer end and a body oriented mainly axially and arranged between said axially outer end and said axially inner end such that, when mounted within the assembly, said axially inner end is intended to be immobilized on said rim, said axially outer end comprising an outer reinforcing element and intended to receive a tyre bead, wherein said outer reinforcement is a structure substantially of revolution about axis X-X′ comprising several windings of at least one wire that are arranged axially beside one another over several layers radially superposed on top of one another, characterized in that the section of the outer reinforcement has a ratio of moments of inertia Ix/Iy of greater than 1.3 for an axial width of between 6 and 9 mm, where Ix is the moment of inertia around a first axis passing through its centre of gravity and parallel to the axis of rotation X-X′, and Iy is the moment of inertia around a second axis passing through its centre of gravity and perpendicular to th adapter e first axis.

In the operating position, when it is mounted within the rolling assembly, the adapter is immobilized with its axially inner end on the rim while the other end forms a bearing surface or seat for the bead of the tyre, the reinforcing element of the axially outer end being located axially on the outside of the tyre bead seat. The reinforcing element of the axially outer end is designed so as to oppose a lot of resistance in bending along an axis parallel to the axis of rotation of the rolling assembly in order to give it mechanical stability in rolling, but also to resist compressive buckling stresses and/or when the rolling assembly is under high inflation pressure. When it undergoes a violent impact, such as an impact against a curb for example, it has been observed that the axially outer end of the adapter undergoes a rotational movement relative to the anchoring point at the level of the rim. By rotating, the axially outer end also causes the outer reinforcing element to rotate around itself, a reinforcing element according to the invention which can then be deformed in bending along an axis having a lower moment of inertia, therefore opposing less resistance to deformation. In other words, the outer reinforcing element of the adapter of the invention is produced so that it has a greater moment of inertia Ix along a first axis substantially parallel to the axis of rotation of the rolling assembly and a lower moment of inertia Iy along a second axis which is perpendicular to the first. In addition, for a restricted axial width of the reinforcing element, a width of between 6 and 9 mm, it has been observed that the ratio between Ix and Iy is greater than 1.3. Thus, the geometry of the outer reinforcing element of the adapter makes it possible to limit the stresses seen by the windings of the reinforcement which have a purely elastic behaviour in operation.

According to the invention, the ratio between Ix and Iy is greater than 1.3, preferably greater than 1.30 and more preferably greater than or equal to 1.35 and even more preferably greater than or equal to 1.38.

The adapter of the invention therefore has sufficient bending stiffness, which makes it possible to confer sufficient rigidity under normal rolling conditions to the rolling assembly which it equips, while having sufficient radial elastic flexibility to allow it to absorb the shocks undergone while rolling by deforming elastically, and while limiting the axial width of its axially outer end which is intended to support the bead of a tyre of the rolling assembly.

The section of the outer reinforcement of the adapter of the invention has an axial width I and a radial height h and may have a form factor h/l of greater than 1.3 and preferably of between 1.3 and 2.

The section of the outer reinforcement of the adapter of the invention has main moments of inertia I1 and I2 with concurrent axes which can make a non-zero angle with Ix and Iy, respectively. By main moments of inertia of a section are to be understood, in a known manner in the resistance of materials, the moments of inertia having the greatest value for I1 and the smallest value for I2, respectively. The main axes of inertia are always perpendicular to one another.

The ratio between the main moments of inertia I1 and I2 can be greater than 2.

The windings of at least one wire of the adapter of the invention form a radially innermost alignment and at least one second adjacent alignment superposed on the first that are termed rows in which the axis passing through the centres of the rows are parallel to one another, and the wires of the most axially innermost alignments form a first column, and the axially outward adjacent alignments form at least one second column where the axes passing through the centres of the wires of the columns are parallel to one another, and where the axis passing through the centre of the windings of a row makes an angle β with the axis passing through the centre of the windings of a wire column, angle β being able to be different from 90°.

The windings of the outer reinforcement of the adapter of the invention may comprise at least two windings arranged axially beside one another over at least three layers radially superposed on one another. The windings of the outer reinforcement of the adapter may be produced on the basis of a unitary metal wire with a diameter of between 2 and 5 mm and preferably of between 2.15 and 3 mm.

The windings of the outer reinforcement of the adapter may be produced on the basis of a unitary metal wire coated with a polymeric composition, preferably an elastomeric composition.

The outer reinforcement of the adapter may be arranged so that the main axis of its section is inclined relative to an axis perpendicular to the axis X-X′ .

The subject of the invention is also a rolling assembly, of axis of rotation X-X′, comprising a tyre having two beads, a rim and an adapter of the invention.

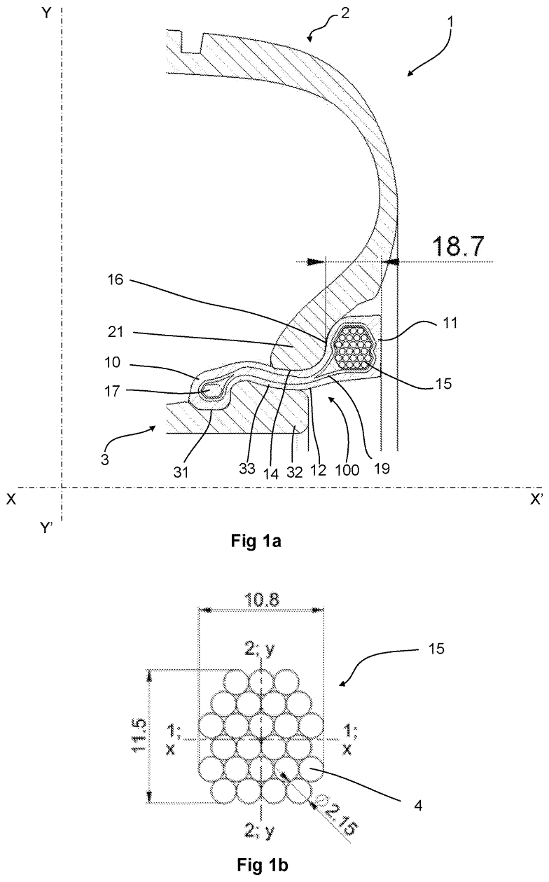

The invention is described below with the aid of FIGS. 1a to 3b, given solely by way of illustration:

FIG. 1a is a partial meridian cross section of a rolling assembly with an adapter according to the prior art,

FIG. 1b is an enlargement of the outer reinforcing element of the adapter of FIG. 1a,

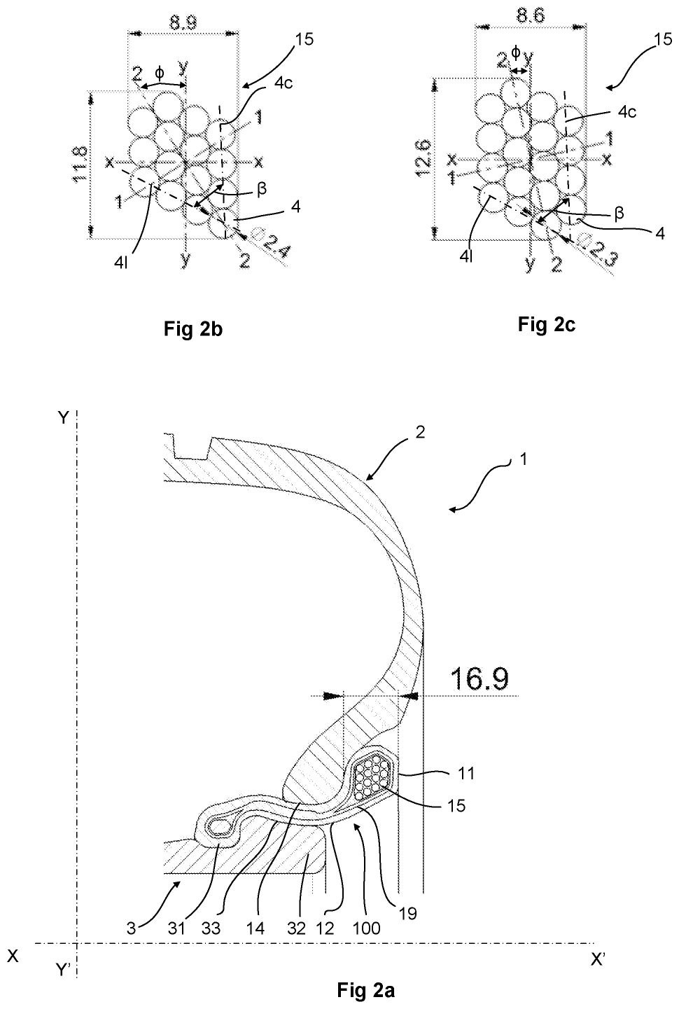

FIG. 2a is a partial meridian cross section of a rolling assembly with an adapter according to a first embodiment of the invention,

FIG. 2b is an enlargement of the outer reinforcing element of the adapter of FIG. 2a,

FIG. 2c is an enlargement of an outer reinforcing element according to an alternative embodiment of the assembly of FIG. 2a,

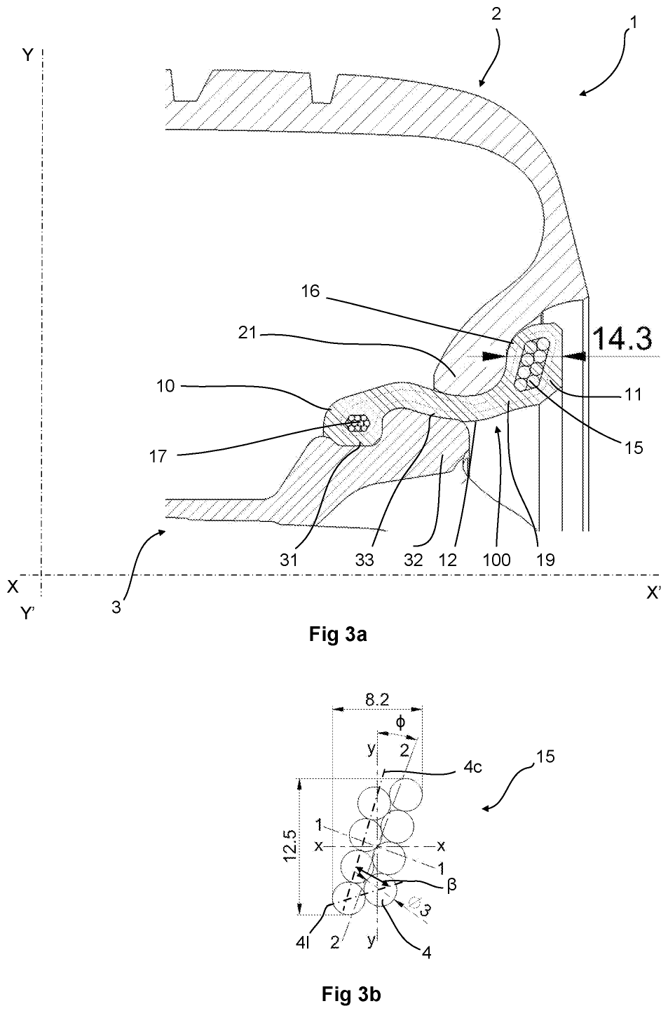

FIG. 3a is a partial meridian cross section of a rolling assembly with an adapter produced according to a second embodiment of the invention,

FIG. 3b is an enlargement of the outer reinforcing element of the adapter of FIG. 3a.

In the various figures, elements that are identical or similar bear the same reference. Their description is therefore not systematically repeated.

FIG. 1a shows a partial view of a rolling assembly 1 according to the prior art. This assembly has an axis of rotation X-X′, an axis Y-Y′ perpendicular to the first and included in a median plane; it comprises two identical adapters 100 (only one being illustrated in the figure), a tyre 2 and a rim 3. The tyre 2 has two beads 21. The rim 3 has two seats on the rim 31, each extended by a rim flange 32. The rim flange 32 has a radially outer bearing face 33 intended to act as a support for the adapter body. The bearing face 33 of the rim flange 32 is in contact with the adapter 100 when the tyre is mounted on the adapters and when the latter are mounted on the rim, the tyre being inflated to nominal pressure.

The adapter 100 has an axially inner end 10 intended to be mounted on one of said seats on the rim 3. It has an axially outer end 11 and a body 12 that is oriented substantially axially and arranged between said axially outer end 11 and said axially inner end 10. The axially inner end 10 of the adapter has an axial positioning face substantially perpendicular to the axis of rotation X-X″, and is immobilized by being pressed axially against the rim flange 32, under the effect of the inflation pressure of the tyre 2 and of a particular geometry of the rim flange. The axially outer end 11 has a shoulder 16 forming a face substantially perpendicular to the axis of rotation X-X′. Said adapter 100 comprises a seat on adapter 14 for the bead 21 of the tyre. The bead 21 is immobilized by being pressed axially on said seat 14 against said shoulder 16 of the axially outer end 11 of the adapter, under the effect of the inflation pressure of the tyre. The adapter thus produced has a shape of revolution around a central axis. When it is in the unmounted state on the rolling assembly, the adapter has a generally annular shape. After its assembly within the rolling assembly, its central axis becomes identical to the axis X-X′ of the rolling assembly.

The axially inner end 10 of the adapter comprises an inner reinforcing element 17 connected to the outer reinforcing element 15 by a reinforcing ply 19 produced on the basis of reinforcing wires embedded in an elastomeric composition. The reinforcing ply 19 forms, with the reinforcing elements 15, 17, an internal structure of the adapter. Other external elastomeric plies surround the internal structure of the adapter.

The assembly is mounted by arranging each adapter 100 on the rim 3 and then mounting the tyre 2 on the adapter 100. Once mounting has been effected, the bead of the tyre causes a circumferential contraction of the adapter 100. The attached figures illustrate the rolling assembly with the elements mounted.

FIG. 1b illustrates the reinforcing element 15 of the adapter of FIG. 1a on an enlarged scale. In the example illustrated in FIG. 1, the width of the axially outer end 11 is 18.7 mm; it is obtained with an annular reinforcement or bead wire produced by several windings of a metal wire 4 having a diameter of 2.15 mm. More particularly, such a bead wire is obtained by winding the metal wire over six radially superposed layers, the first, radially innermost layer having 4 windings; it is followed by a second having 5 windings, a third having 4 windings, a fourth having five windings, a fifth which has 4 windings and finally the last layer which has three windings. The windings of two adjacent layers are axially offset with respect to one another, and they form mutually parallel rows corresponding to the axial windings, and the windings of the radially superposed layers form mutually parallel columns. The windings are produced in a known manner, so that the axis passing through the centre of the windings of a row is perpendicular to the axis of the windings of a column. The section of the bead wire thus obtained has a width “I” equal to 10.8 mm and a height “h” equal to 11.5 mm. The calculated moments of inertia of the section of the bead wire, in particular the moment Ix calculated along a first axis x-x′ which is parallel to the axis of rotation X-X′ of the assembly and passing through the centre of gravity of the section are equal to 854 mm4, and the moment of inertia Iy along a second axis perpendicular to the first and passing through the centre of gravity of the section is equal to 647 mm4. The main moments of inertia I1 and I2 are equal to Ix and Iy, respectively. With the rolling assembly of FIG. 1a functioning satisfactorily, it has, however, been observed that the axially outer end 11 of the adapter being too protruding (it has an axial width of 18.7 mm in the example of FIG. 1a), it was exposed to curb scrapings and risked being damaged when driving.

The invention proposes a solution according to the examples illustrated in FIGS. 2a to 3b.

FIG. 2a shows, in partial meridian cross section, an embodiment of an adapter 100 according to a first embodiment of the invention.

This adapter differs from that illustrated in FIG. 1a by an axial end 11 having a reduced axial width, of the order of 16.9 mm, while having an excellent capacity to deform elastically during an impact, such as impact of the wheel against the curb, for example. This reduced axial width is obtained with the aid of a bead wire or outer reinforcing element 15, the section of which has an advantageous geometry.

Thus, as better visible in FIG. 2b, an outer reinforcing element 15 has been produced which is a structure substantially of revolution about the axis X-X′ comprising several windings of a wire 4 arranged axially beside one another over several layers radially superposed on one another, and the geometry of the section of which is such that the ratio of the moments of inertia Ix/Iy is greater than 1.3. More particularly, the outer reinforcement 15 was obtained on the basis of a metal wire 4 of round section, the diameter of the wire being equal to 2.4 mm, and by producing four windings arranged axially beside one another over three layers radially superposed on one another and comprising a radially outer fourth layer with three windings. These windings thus form four wire rows 4I parallel to one another and four wire columns 4c parallel to one another. According to the invention, the axis passing through the centres of the wires of a row 4I makes an angle β with the axis passing through the centres of the wires of a column 4c, an angle which is different from 90°. More particularly, the angle β is equal to 60°.

The section of the outer reinforcing element 15 of FIG. 2b thus obtained has an axial width “I” equal to 8.9 mm and a radial height “h” equal to 11.8 mm. The calculated moments of inertia of the section of the reinforcing element, in particular the moment Ix calculated along a first axis x-x′ which is parallel to the axis of rotation X-X′ of the assembly and passing through the centre of gravity of the section, are equal to 525 mm4, and the moment of inertia Iy along a second axis perpendicular to the first and passing through the centre of gravity of the section is equal to 379 mm4. The main moments of inertia I1 and I2, of concurrent axes, make an angle φ equal to 30° with the axes of the respective moments of inertia Ix and Iy, and their values calculated for the section of FIG. 2b are 619 mm4 for I1 and 285 mm4 for I2. By main moments of inertia of a section are to be understood, in a known manner in the resistance of materials, the moments of inertia having the greatest value for I1 and the smallest value for I2, respectively. The associated main axes of inertia 1-1 and 2-2 are always perpendicular to each other.

Such an outer reinforcing element 15 is produced on the basis of a metal wire, such as a steel wire, preferably comprising a steel core preferably covered with brass, the wire being coated with a polymeric composition, preferably an elastomeric composition to ensure cohesion between the wires. The winding is done by spooling, layer by layer, on a support in the form of an inclined plane. More precisely, there is chosen a support inclined at an angle 90°-β=30° in this case and a start is made by producing a first radially inner layer 41 starting from the end having the smallest diameter, and this is then continued by producing the second layer radially superposed on the first by winding the same wire from the end corresponding to that of the last winding of the first layer, by spooling in the opposite direction to the first. Wire windings are thus continued to be produced by spooling in one direction, then in the other, to produce four radially superposed layers, the first three of which have four windings and the last only three windings so as to obtain the section shown in FIG. 2b.

A variant of this embodiment is shown in FIG. 2c. More particularly, the outer reinforcement 15 was obtained on the basis of a metal wire 4 of round section, the diameter of the wire being equal to 2.3 mm, and by producing a first radially inner layer of three windings arranged axially beside one another, followed by three other radially superposed layers each having four windings arranged axially against one another over three and which ends with a fifth layer radially superposed on the previous ones and three windings arranged axially against one another. These windings thus form five wire rows 41 parallel to one another and four wire columns 4c parallel to one another. According to the invention, the axis passing through the centres of the wires of a row 41 makes an angle β with the axis passing through the centres of the wires of a column 4c, an angle which is different from 90°. More particularly, the angle β is equal to 60°.

The section of the outer reinforcing element 15 of FIG. 2c thus obtained has an axial width “I” equal to 8.6 mm and a radial height “h” equal to 12.6 mm. The calculated moments of inertia of the section of the reinforcing element, in particular the moment Ix calculated along a first axis x-x′ which is parallel to the axis of rotation X-X′ of the assembly and passing through the centre of gravity of the section, are equal to 703 mm4, and the moment of inertia Iy along a second axis perpendicular to the first and passing through the centre of gravity of the section is equal to 369 mm4. The main moments of inertia I1 and I2 with concurrent axes make an angle φ equal to 14° with the axes of the moments of inertia Ix and Iy, respectively, and their values calculated for the section of FIG. 2b are 727 mm4 for I1 and 345 mm4 for I2.

Such an outer reinforcing element 15 of FIG. 2c is produced in the same manner as that described with reference to the reinforcing element of FIG. 2b, by spooling in one direction, then in the other, on an inclined support starting from the end having the smallest diameter to obtain five radially superposed layers, the first having three windings, the next three each having four windings, and the last three axial windings.

FIGS. 3a and 3b illustrate a second embodiment of an adapter according to the invention. Specifically, the particular geometry of the section of the outer reinforcing element 15 makes it possible to obtain an adapter 100 with a very reduced axial width, being equal to 14.3 mm, which ensures good protection of the adapter during curb scrapings, while giving it excellent ability to deform elastically during an impact, such as the impact of the wheel against the curb for example, and mechanical stability when rolling.

Thus, as better visible in FIG. 3b, an outer reinforcing element 15 has been produced which is a structure substantially of revolution about the axis X-X′ and comprises several windings of a metal wire 4 of round section and of a diameter equal to 3 mm, the structure comprising two windings arranged axially one beside the other over four layers radially superposed on one another. These windings thus form four wire rows 4I parallel to one another and two wire columns 4c parallel to one another. According to the invention, the axis passing through the centres of the wires of a row 4I makes an angle β with the axis passing through the centres of the wires of a column 4c, an angle which is different from 90°. More particularly, the angle β is equal to 60°.

The section of the outer reinforcing element 15 of FIG. 3b thus obtained has an axial width “I” equal to 8.2 mm and a radial height “h” equal to 12.5 mm. The calculated moments of inertia of the section of the reinforcing element, in particular the moment Ix calculated along a first axis x-x′ which is parallel to the axis of rotation X-X′ of the assembly and passing through the centre of gravity of the section, are equal to 634 mm4, and the moment of inertia Iy along a second axis perpendicular to the first and passing through the centre of gravity of the section is equal to 193 mm4. The main moments of inertia I1 and I2 with concurrent axes make an angle φ equal to 20.4° with Ix and Iy, respectively, and their values calculated for the section of FIG. 3b are 705 mm4 for I1 and 122 mm4 for I2.

Such an outer reinforcing element 15 of FIG. 3b is produced in a manner similar to that previously described by producing windings of metal wire coated with elastomeric composition side by side on a support inclined at an angle of 90°-β, by spooling in one direction, then in the other, on an inclined support starting from the end having the smallest diameter to obtain four radially superposed layers, each having two axial windings.

In a variant, not illustrated in the figures, the reinforcing element of FIG. 3b is modified. Thus, the last radially outer layer superposed on the previous three comprises only one winding, the last axially outward winding being omitted, while the other layers below each comprise two windings, as in FIG. 3b. This makes it possible to have a reinforcing element of smaller radial size, while retaining the required mechanical properties.

As illustrated in FIGS. 2a, 2b, 2c, 3a and 3b, the moment of inertia along the axis Ix is different from the moment of inertia along the main axis I1, and the moment of inertia along the axis Iy is different from the moment of inertia along the main axis I2. More particularly, the main axes 1-1 and 2-2 of the main moments I1 and I2 make an angle φ with the axes x-x′ and yy′, respectively, of the moments Ix and Iy, respectively. This angle of inclination φ is present from the production of the windings of the outer reinforcement and is such that the intersection between the extension of the axis 2-2 with the axis X-X′ of the wheel is on the inner side of the wheel or, in other words, such that it makes it possible to arrange the outer reinforcement so that the longitudinal direction of the windings of the outer reinforcement 15 is oriented outwards when the adapter is in place within the rolling assembly in order to anticipate the rotational movement assumed by the section of the outer reinforcement in the event of a violent impact suffered by the assembly. By longitudinal direction of the windings is to be understood a direction parallel to the largest dimension of the section of the reinforcement.

More particularly, the outer reinforcement 15 is arranged so that the longitudinal direction of the windings is inclined outwards with respect to an axis perpendicular to the axis of rotation X-X′ of the rolling assembly when the adapter is in a mounted position within the assembly. Such an outward inclination makes it possible to anticipate the rotational movement undergone by the outer reinforcing element during an impact and therefore to help the outer reinforcing element to initiate the rotational movement when it undergoes a violent impact.

The shape of the section of the outer reinforcing element according to the invention has a radial height “h” markedly greater than its axial width “I”, for a form factor h/l of greater than 1.3. The ratio of the moments of inertia Ix/Iy is also greater than 1.3. There is thus obtained sufficient rigidity to ovalization and therefore mechanical stability in normal operation of the rolling assembly (characterized by the moment of inertia about an axis parallel to that of rotation of the rolling assembly). During an impact against a curb, for example, the rolling assembly equipped with the adapter of the invention leads to an elastic deformation of the latter, which is a progressive displacement of the section of the outer reinforcement in the plane of the impact. Thus, the greater the deformation, the more this reinforcement rotates around itself and the more the inertia around the axis x-x′ decreases, thus making it possible to limit the stress seen by the wires which enter into the constitution of the reinforcement. In addition, the outer reinforcement thus produced allows weight and size savings.

Other variants and embodiments of the invention may be envisaged without departing from the scope of its claims. Thus, the outer reinforcement, the section of which has the general shape of a parallelogram in FIG. 3b, may have a section of generally rectangular shape, the moments of inertia of which are I1=Ix and I2=Iy.

In one variant, a metal wire not covered with a polymeric composition is used. In yet another variant, metal wires of different diameters are used to produce the windings constituting the outer reinforcement of the adapter of the invention.

1.-10. (canceled)

11. An adapter for a rolling assembly, of axis of rotation X-X′, comprising a tire, having two beads and a rim,
the adapter being intended to provide a junction between one of the beads and the rim,
the adapter comprising an axially inner end, an axially outer end and a body oriented mainly axially and arranged between the axially outer end and the axially inner end, so that, when mounted within the assembly, the axially inner end is intended to be immobilized on the rim,
the axially outer end comprising an outer reinforcing element and intended to receive a bead of the tire,
wherein the outer reinforcing element is a structure substantially of revolution about the axis X-X′ comprising several windings of at least one wire that are arranged axially beside one another over several layers radially superposed on each other, and
wherein a section of the outer reinforcing element has a ratio of moments of inertia Ix/Iy greater than 1.3 for an axial width of between 6 and 9 mm, where Ix is the moment of inertia around a first axis passing through its center of gravity and parallel to the axis of rotation X-X′, and Iy is the moment of inertia around a second axis passing through its center of gravity and perpendicular to the first axis.

12. The adapter according to claim 11, wherein the section of the outer reinforcing element having an axial width 1 and a radial height h has a form factor h/l of greater than 1.3.

13. The adapter according to claim 11, wherein the section of the outer reinforcing element has main moments of inertia I1 and I2 of concurrent axes which form a non-zero angle with Ix and Iy, respectively.

14. The adapter according to claim 13, wherein a ratio between the main moments of inertia I1 and I2 is greater than 2.

15. The adapter according to claim 11, wherein the windings form a radially innermost alignment and at least one second adjacent alignment superposed on the first radially innermost alignment that are termed rows in which the axis passing through the centers of the rows are parallel to one another, and the wires of the axially innermost alignments form a first column, and the axially outward adjacent alignments form at least one second column, where the axes passing through the centers of the wires of the columns are parallel to one another, and where the axis passing through the center of the windings of a row makes an angle β with the axis passing through the center of the windings of a wire column, and wherein the angle β is different from 90°.

16. The adapter according to claim 11, wherein the windings of the outer reinforcing element comprise at least two windings arranged axially beside one another over at least three layers radially superposed on one another.

17. The adapter according to claim 11, wherein the windings of the outer reinforcing element are produced using a unitary metal wire with a diameter of between 2 and 5 mm.

18. The adapter according to claim 11, wherein the windings of the outer reinforcing element are produced using a unitary metal wire coated with a polymeric composition.

19. The adapter according to claim 11, wherein the outer reinforcing element is arranged so that the main axis of its section is inclined with respect to an axis perpendicular to the axis X-X′.

20. A rolling assembly, of axis of rotation X-X′, comprising a tire, having two beads, a rim, and the adapter according to claim 11 that is intended to provide the junction between one of the beads and the rim.
